(19) United States
(12) Patent Application Publication
(10) Pub. No.: US 2016/0263834 A1
(43) Pub. Date: Sep. 15, 2016

(54) THREE-DIMENSIONAL MODELING APPARATUS AND MANUFACTURING METHOD

(71) Applicant: SEIKO EPSON CORPORATION, Tokyo (JP)

(72) Inventor: Hiroshi WADA, Nagano (JP)

(21) Appl. No.: 15/061,417

(22) Filed: Mar. 4, 2016

(30) Foreign Application Priority Data
Mar. 13, 2015 (JP) 2015-050169

(51) Int. Cl. B29C 67/00

(52) U.S. Cl. CPC B29C 67/0088; B29C 67/0059; B29K 2105/0058

(57) ABSTRACT

A three-dimensional modeling apparatus is provided with a head unit for modeling an object by discharging a liquid, which is to be a material of the object, into each unit grille and a control unit for controlling the head unit. The head unit is capable of individually discharging, into the unit grille, designated amounts of a plurality of types of chromatic liquids for expressing a designated color, and a low-lightness liquid that is an achromatic liquid having a lower lightness than the chromatic liquids, and in the case of discharging the low-lightness liquid and a chromatic liquid into one unit grille, the control unit controls the head unit so as to discharge the liquids such that the low-lightness liquid is positioned on an interior side of the object relative to the chromatic liquid.

### BACKGROUND

1. Technical Field

The present invention relates to a three-dimensional modeling apparatus.

2. Related Art

In recent years, three-dimensional modeling apparatuses that adopt an inkjet technique have been attracting attention. With three-dimensional modeling apparatuses that adopt an inkjet technique, a three-dimensional object is modeled by performing, over a number of layers in the height direction (Z direction), a step of discharging a liquid having curability and forming a cross section body for one layer that lies in the horizontal direction (XY directions). For example, with a three-dimensional modeling apparatus described in JP-A-2011-73163, the color intensity is expressed by superimposing layers in which a peripheral portion is colored and layers in which a peripheral portion is not colored.

JP-A-2011-73163, JP-A-2001-150556, JP-A-2005-67138 and JP-A-2010-58519 are examples of related art.

However, with the technique described in JP-A-2011-73163, only one color can be expressed for each layer, and therefore there is a problem in that, when observed from outside, color reproducibility deteriorates. Therefore, a technique that improves color reproducibility in a technique for modeling a colored three-dimensional object by discharging a liquid is demanded.

### SUMMARY

An advantage of some aspects of the invention is to solve at least some of the above-described problems, and the invention can be achieved as the following modes.

(1) According to one mode of the invention, a three-dimensional modeling apparatus for modeling a three-dimensional object by laminating a plurality of cross section bodies in a Z direction is provided. This three-dimensional modeling apparatus includes: a head unit for modeling the object by discharging a liquid, which is to be a material of the object, into each unit grille that is defined in accordance with a modeling resolution of the cross section body in an X direction, a modeling resolution of the cross section body in a Y direction, and a lamination interval of the cross section body in the Z direction; and a control unit for controlling the head unit. The head unit is capable of individually discharging, into the unit grille, designated amounts of a plurality of types of chromatic liquids for expressing a designated color, and a low-lightness liquid that is an achromatic liquid having a lower lightness than the chromatic liquid, and in a case of discharging the low-lightness liquid and the chromatic liquid into one unit grille, the control unit controls the head unit so as to discharge the liquids such that the low-lightness liquid is positioned on an interior side of the object relative to the chromatic liquid.

With the three-dimensional modeling apparatus of such a mode, the amount of chromatic liquid to be discharged into the unit grille can be adjusted in units finer than the unit grille, and therefore, when modeling a colored three-dimensional object, it is possible to suppress the deterioration of the apparent resolution of the three-dimensional object. In addition, the low-lightness liquid such as a black liquid and the chromatic liquid are discharged such that the low-lightness liquid is positioned on the interior side of the object relative to the chromatic liquid, and therefore it is possible to suppress the deterioration of chromatic color reproducibility due to the low-lightness liquid, when observed from the surface of the object.

(2) In the three-dimensional modeling apparatus of the above mode, in the case of discharging the low-lightness liquid and the chromatic liquid into two unit grilles that are adjacent to each other in a direction from a surface to an interior of the object, the control unit may control the head unit so as to discharge the chromatic liquid into a first unit grille positioned on the surface side of the object, and discharge the low-lightness liquid into a second unit grille positioned on the interior side of the object.

With the three-dimensional modeling apparatus of such a mode as well, the low-lightness liquid is positioned on the interior side of the object relative to the chromatic liquid, and therefore it is possible to suppress the deterioration of chromatic color reproducibility due to the low-lightness liquid, when observed from the surface of the object.

(3) In the three-dimensional modeling apparatus of the above mode, the head unit may be further capable of discharging a colorless liquid into the unit grille, and the control unit may control the head unit so as to discharge at least one colored liquid out of the chromatic liquid and the low-lightness liquid into the unit grille and, in the case where the spatial volume of the unit grille is not filled with the colored liquid, discharge the colorless liquid into the unit grille in addition to the colored liquid, such that the spatial volume of the unit grille is filled.

With the three-dimensional modeling apparatus of such a mode, in the case where the spatial volume of a unit grille is not filled with the amount of colored liquid discharged into the unit grille, the remaining spatial volume of the unit grille is filled with a colorless liquid. Therefore, the volumes of the unit grilles are uniformized, and the three-dimensional object can be accurately modeled.

(4) In the three-dimensional modeling apparatus of the above mode, the head unit may discharge the liquids into the unit grilles while scanning in a predetermined direction, and be provided with a plurality of nozzle groups for discharging the liquids, and in a main scanning direction of the head unit, a second nozzle group for discharging the low-lightness liquid into the unit grilles may be arranged rearward of a first nozzle group for discharging the chromatic liquid into the unit grilles, a third nozzle group for discharging the colorless liquid into the unit grilles may be arranged rearward of the second nozzle group, and a fourth nozzle group for discharging the colorless liquid into the unit grilles may be arranged rearward of the third nozzle group.

With the three-dimensional modeling apparatus of such a mode, the low-lightness liquid can be discharged from the second nozzle group after the chromatic liquid is discharged from the first nozzle group, and therefore the low-lightness liquid can be easily arranged on the interior side of the object relative to the chromatic liquid. In addition, for example, even in the case where the total amount of liquids discharged from the first nozzle group and the second nozzle group is small, and the amount of colorless liquid necessary to fill the unit grille with a liquid is larger than the amount that can be discharged from either the third nozzle group or the fourth nozzle group, a colorless liquid is sequentially discharged from two nozzle groups, namely, the third nozzle group and the fourth nozzle group, thereby making it possible to fill the unit grille with a liquid. Therefore, the volumes of the unit grilles can be uniformized more easily.

(5) In the three-dimensional modeling apparatus of the above mode, the head unit may be further capable of discharging a colorless liquid into the unit grille, and the control unit may control the head unit so as to discharge the colorless liquid onto the top portion of the unit grille into which at least one of the chromatic liquid and the low-lightness liquid was discharged.

With the three-dimensional modeling apparatus of such a mode, it is possible to uniformize the way that the chromatic liquid and the low-lightness liquid discharged into the unit grille spread in the unit grille, making it possible to reduce the variation in color for each unit grille. In other words, the way that a colored liquid, which is at least one of the chromatic liquid and the low-lightness liquid discharged into the unit grille, spreads after landing is different in the case of landing on another colored liquid, and in the case of landing on the colorless liquid. Therefore, by the colorless liquid constituting the top portion of the unit grille, it is possible to cause the colored liquid that is to be discharged into a unit grille above this unit grille to land on the colorless liquid in a stable manner. Thereby, it is possible to uniformize the way that a chromatic liquid and a black liquid after landing spread, making it possible to reduce the variation in color due to the difference in the manner of the spreading.

The invention can also be achieved in various modes other than modes as a three-dimensional modeling apparatus. For example, the invention can be achieved in modes such as a method for manufacturing a three-dimensional object using a three-dimensional modeling apparatus, a computer program for causing a computer to control a three-dimensional modeling apparatus to model a three-dimensional object, and a non-transitory tangible recording medium on which the computer program is recorded.

### BRIEF DESCRIPTION OF THE DRAWINGS

The invention will be described with reference to the accompanying drawings, wherein like numbers reference like elements.

FIG. 1 is an explanatory diagram showing a schematic configuration of a three-dimensional modeling apparatus as a first embodiment.

FIG. 2 is an explanatory diagram showing a schematic configuration of a head unit.

FIG. 3 is a flowchart of three-dimensional modeling processing.

FIGS. 4A and 4B are diagrams for explaining a method for modeling a three-dimensional object.

FIGS. 5A to 5D are diagrams for explaining a method for expressing a color of a bottom surface of an object.

FIGS. 6A to 6D are diagrams for explaining a method for expressing a color of a side surface of an object.

FIGS. 7A to 7D are diagrams for explaining a method for expressing a color of a bottom surface of an object in modifications.

FIGS. 8A to 8F are diagrams showing examples of unit grilles in a second embodiment.

FIGS. 9A and 9B are diagrams showing examples of unit grilles in a third embodiment.

FIG. 10 is an explanatory diagram showing a schematic configuration of a head unit of a fourth embodiment.

FIG. 11 is an explanatory diagram showing a schematic configuration of a three-dimensional modeling apparatus of a fifth embodiment.

### DESCRIPTION OF EXEMPLARY EMBODIMENTS

### A1. First Embodiment

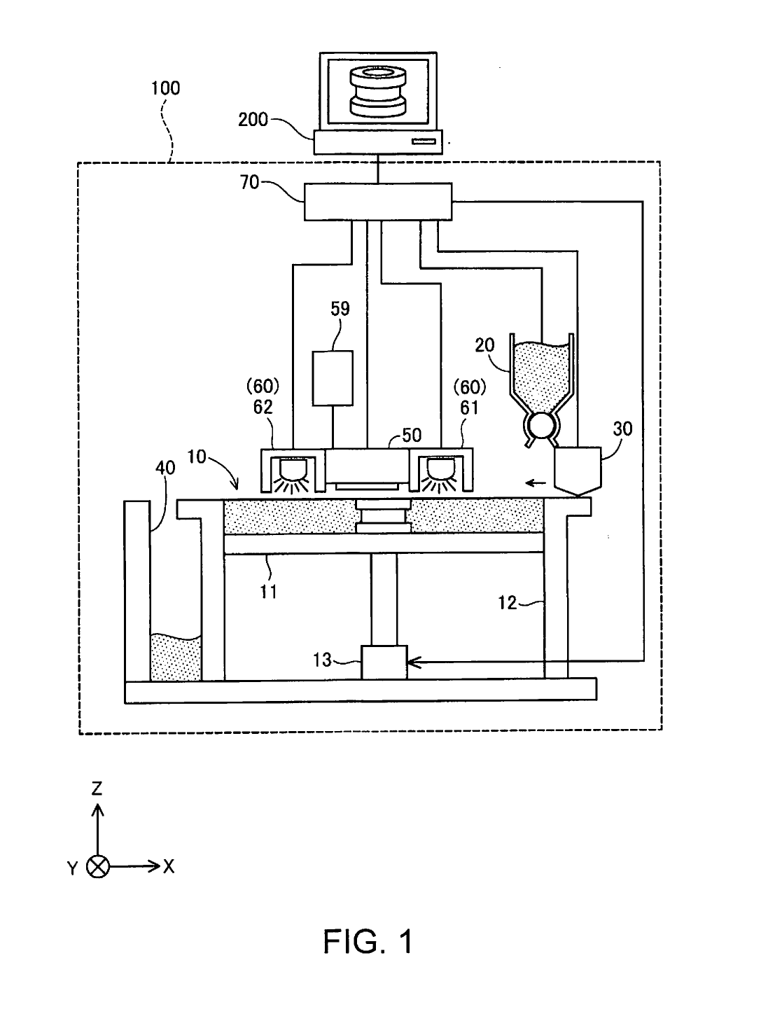

FIG. 1 is an explanatory diagram showing the schematic configuration of a three-dimensional modeling apparatus as a first embodiment of the invention. A three-dimensional modeling apparatus 100 is provided with a modeling unit 10, a powder supply unit 20, a flattening mechanism 30, a powder collecting unit 40, a head unit 50, a curing energy applying unit 60, and a control unit 70. A computer 200 is connected to the control unit 70. The three-dimensional modeling apparatus 100 and the computer 200 can be collectively regarded as a “three-dimensional modeling apparatus” in a broad sense. In FIG. 1, an X direction, a Y direction and a Z direction that intersect orthogonally to one another are shown. The Z direction is a direction along a vertical direction, and the X direction is a direction along a horizontal direction. The Y direction is a direction perpendicular to the Z direction and the X direction.

The modeling unit 10 is a tank-shaped structure in which a three-dimensional object is modeled. The modeling unit 10 is provided with a modeling stage 11 that is flat and lies in an XY direction, a frame body 12 surrounding the periphery of the modeling stage 11 and erect in the Z direction, and an actuator 13 for moving the modeling stage 11 in the Z direction. The modeling stage 11 moves in the Z direction in the frame body 12 by the control unit 70 controlling the operations of the actuator 13.

The powder supply unit 20 is an apparatus for supplying powder into the modeling unit 10. The powder supply unit 20 is constituted by a hopper or a dispenser, for example.

The flattening mechanism 30 is a mechanism for flattening the powder supplied into the modeling unit 10 or on the frame body 12 and forming a powder layer on the modeling stage 11 by moving over the upper surface of the modeling unit 10 in the horizontal direction (XY directions). The flattening mechanism 30 is constituted by a squeegee or a roller, for example. The powder pushed out from the modeling unit 10 by the flattening mechanism 30 is discharged into the powder collecting unit 40 provided adjacent to the modeling unit 10.

The three-dimensional modeling apparatus 100 in the first embodiment uses a liquid having curability (hereinafter, referred to as “curable liquid”) and the above powder as materials of a three-dimensional object. A mixture of a liquid resin material that is mainly composed of monomers and oligomers to which monomers are bonded, and a polymerization initiator that enters an excited state when irradiated with ultraviolet light, and acts on the monomers or the oligomers so as to start polymerization is used as a curable liquid. In addition, as the monomers of the resin material, relatively low molecular weight monomers are selected, and furthermore, the number of monomers included in one oligomer of the resin material is adjusted to be about a few molecules such that the curable liquid has a low viscosity that allows droplets to be discharged from the head unit 50. This curable liquid has a property of quickly curing and becoming a solid when the curable liquid is irradiated with ultraviolet light and the polymerization initiator is in an excited state, the monomers polymerize with one another and grow into oligomers, and the oligomers also polymerize with one another in places.

In this embodiment, powder particles on the surface of which a polymerization initiator of a different type from that contained in the curable liquid are attached is used as the powder. The polymerization initiator attached to the surface of the powder particles has a property of acting on the monomers or the oligomers so as to start polymerization when coming into contact with the curable liquid. Therefore, when the curable liquid is supplied to the powder in the modeling unit 10, the curable liquid permeates into the powder, comes into contact with the polymerization initiator on the surface of the powder particles, and cures. As a result, in a portion onto which the curable liquid is discharged, powder particles are coupled with one another by the curable liquid that has cured. Note that in the case of using, as the powder, powder particles having a polymerization initiator attached to the surface thereof, a curable liquid that does not contain a polymerization initiator can also be used.

The head unit 50 is an apparatus that receives supply of the above-described curable liquid from a tank 59 connected to the head unit 50 and discharges, in the Z direction, the curable liquid onto the powder layer in the modeling unit 10. In this embodiment, the head unit 50 can discharge, as the curable liquid, colorless ink that has not been colored, and a plurality of types of colored ink that has been colored. The head unit 50 can move in the X direction and the Y direction with respect to the three-dimensional object that is modeled in the modeling unit 10. In addition, the head unit 50 can move in the Z direction relative to the three-dimensional object, by the modeling stage 11 inside of the modeling unit 10 moving in the Z direction.

The head unit 50 of this embodiment is a so-called piezoelectric drive type droplet discharging head. By filling a pressure chamber having a minute nozzle hole with the curable liquid and bending the sidewall of the pressure chamber using a piezoelectric element, the piezoelectric drive type droplet discharge head can discharge, as droplets, a curable liquid with a volume corresponding to the reduced volume of the pressure chamber. The control unit 70 that is described later can adjust the amount of the curable liquid per droplet to be discharged from the head unit 50 by controlling the waveform of the voltage to be applied to the piezoelectric element.

The curing energy applying unit 60 is an apparatus for applying energy for curing the curable liquid discharged from the head unit 50. In this embodiment, the curing energy applying unit 60 is constituted by a main curing light emitting apparatus 61 and a provisional curing light emitting apparatus 62 that are arranged so as to sandwich the head unit 50 in the X direction. When the head unit 50 is moved, the curing energy applying unit 60 also moves with the head unit 50. Ultraviolet rays as curing energy for curing the curable liquid are emitted from the main curing light emitting apparatus 61 and the provisional curing light emitting apparatus 62. The provisional curing light emitting apparatus 62 is used for performing provisional curing to fix the discharged curable liquid at the landing position thereof. The main curing light emitting apparatus 61 is used for completely curing the curable liquid after provisional curing. The energy of the ultraviolet rays emitted from the provisional curing light emitting apparatus 62 is 20 to 30% of the energy of the ultraviolet rays emitted from the main curing light emitting apparatus 61, for example.

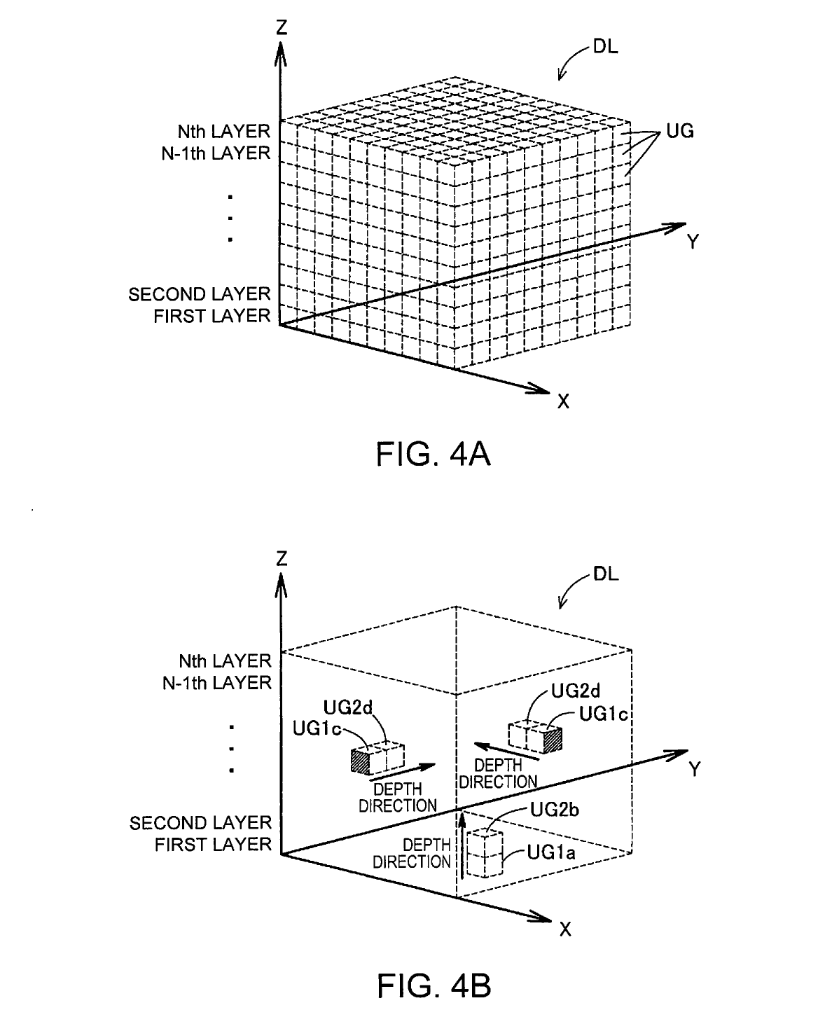

The control unit 70 is provided with a CPU and a memory. The CPU has a function of modeling a three-dimensional object by controlling the actuator 13, the powder supply unit 20, the flattening mechanism 30, the head unit 50 and the curing energy applying unit 60 by loading a computer program stored in the memory or a recording medium to the memory and executing the program. This function includes a function of controlling the head unit 50 so as to cause colored ink and colorless ink to be discharged into a unit grille UG (see FIG. 4), which is described later, such that the spatial volume of the unit grille UG is filled with the colored ink and colorless ink. This function also includes a function of discharging colored ink into two unit grilles UG adjacent to each other, and expressing one color using the combination of the colored ink discharged into the two unit grilles UG. Note that these functions may be realized by an electronic circuit.

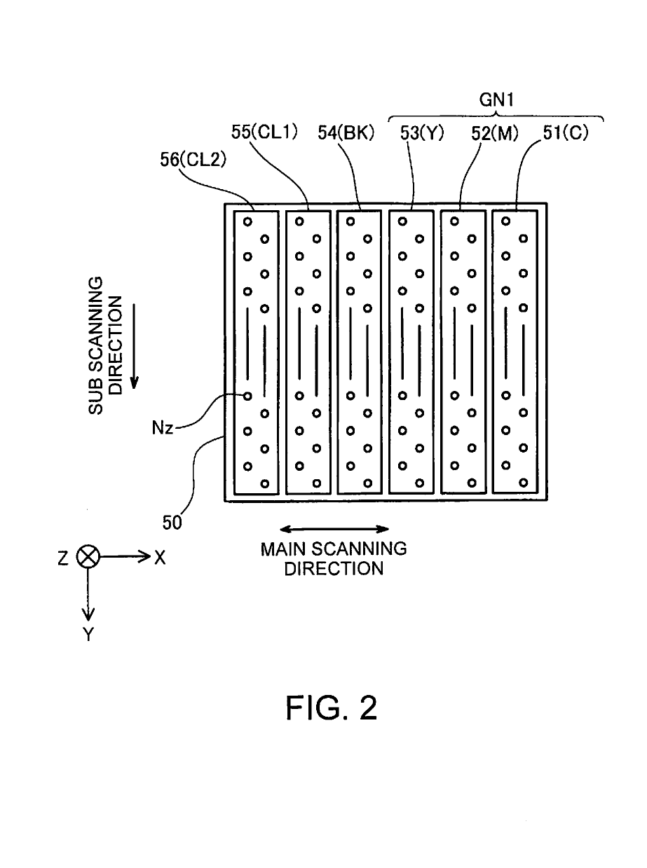

FIG. 2 is an explanatory diagram showing the schematic configuration of the head unit 50. In this embodiment, the head unit 50 can discharge transparent (CL) ink as colorless ink, as well as cyan (C) ink, magenta (M) ink, yellow (Y) ink, and black (BK) ink as colored ink. Note that colors of the ink discharged from the head unit 50 are not limited thereto. For example, the head unit 50 may be configured to be able to discharge white (W) ink. In the head unit 50, a first A nozzle group 51 for discharging droplets of cyan (C) ink, a first B nozzle group 52 for discharging droplets of magenta (M) ink, a first C nozzle group 53 for discharging droplets of yellow (Y) ink, a second nozzle group 54 for discharging droplets of black (BK) ink, and a third nozzle group 55 and a fourth nozzle group 56 for discharging droplets of transparent (CL) ink are aligned in this order in the main scanning direction (X direction). In order to distinguish between the transparent ink discharged from the third nozzle group 55 and the transparent ink discharged from the fourth nozzle group 56, the transparent ink discharged from the third nozzle group 55 is also referred to as “first clear ink CL1”, and the transparent ink discharged from the fourth nozzle group 56 is also referred to as “second clear ink CL2”, hereinafter. In addition, in the case of distinguishing between the colored ink C, M, Y and the colored ink BK, the ink C, M, and Y is also referred to as “chromatic ink”. The first A nozzle group 51, the first B nozzle group 52 and the first C nozzle group 53 for discharging the chromatic ink are also collectively referred to as “first nozzle group GN1”. The types of chromatic ink discharged from the nozzle groups 51 to 53 are not limited to the above. In addition, the ink that is discharged from the second nozzle group 54 is not limited to black (BK) ink as long as it is an achromatic liquid having a lower lightness than the chromatic ink discharged from the first nozzle group GN1. For example, gray ink may be discharged from the second nozzle group 54. In the nozzle groups 51 to 56, a plurality of nozzles Nz are aligned in zigzags in a sub scanning direction (Y direction). Note that in each of the nozzle groups 51 to 56, the nozzles Nz may be linearly aligned. The side on which the first A nozzle group 51 is formed is also referred to as “the front side of the head unit 50”, and the side on which the fourth nozzle group 56 is formed is also referred to as “the rear side of the head unit 50”. Black (BK) ink in this embodiment corresponds to “low-lightness liquid” in the claims.

A method for modeling (manufacturing) a three-dimensional object using the three-dimensional modeling apparatus 100 (FIG. 1) will be briefly described. The computer 200 first slices polygon data indicating the shape of the three-dimensional object in accordance with a modeling resolution (lamination pitch) in the Z direction, and generates a plurality of cross section data in the XY directions. This cross section data has a predetermined modeling resolution in the X direction and the Y direction, and is represented by two-dimensional bitmap data in which for each element, the type and amount of curable liquid (colored ink and colorless ink) to be discharged at a corresponding XY coordinate are stored. That is, in this embodiment, bitmap data designates, for the control unit 70 of the three-dimensional modeling apparatus 100, a coordinate for which the curable liquid is to be discharged and the type and amount of the curable liquid to be discharged.

Upon acquiring the cross section data from the computer 200, the control unit 70 of the three-dimensional modeling apparatus 100 forms a powder layer in the modeling unit 10 by controlling the powder supply unit 20 and the flattening mechanism 30. The control unit 70 then drives the head unit 50 so as to discharge the curable liquid onto the powder layer in accordance with the cross section data, subsequently controls the curing energy applying unit 60 so as to emit ultraviolet light toward the discharged curable liquid, and performs provisional curing and main curing. The curable liquid then cures due to the ultraviolet light, powder particles are coupled with one another, and a cross section body corresponding to cross section data for one layer is formed in the modeling unit 10. When the cross section body for one layer is formed in this manner, the control unit 70 drives the actuator 13 so as to lower the modeling stage 11 in the Z direction for a lamination pitch that is in accordance with a modeling resolution in the Z direction. When the modeling stage 11 has been lowered, the control unit 70 forms a new powder layer on the cross section body that has already been formed on the modeling stage 11. When the new powder layer is formed, the control unit 70 receives next cross section data from the computer 200 and forms a new cross section body by discharging the curable liquid onto the new powder layer and emitting ultraviolet light. In this manner, on receiving cross section data for each layer from the computer 200, the control unit 70 controls the actuator 13, the powder supply unit 20, the flattening mechanism 30, the head unit 50, and the curing energy applying unit 60 so as to form a cross section body for each layer, and consecutively laminates cross section bodies, thereby modeling a three-dimensional object.

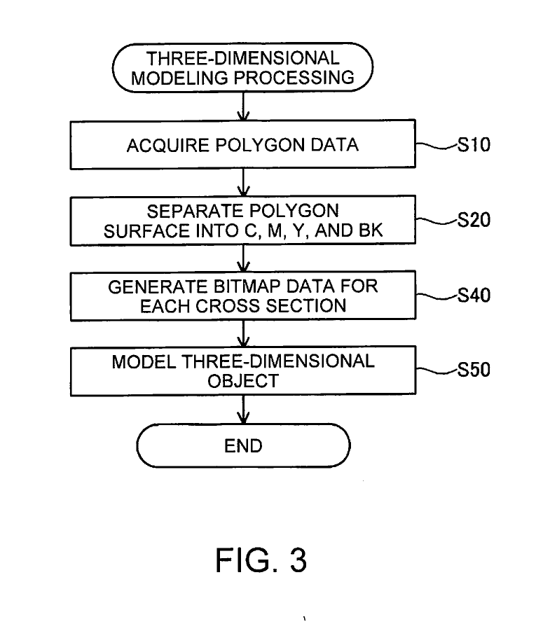

FIG. 3 is a specific flowchart of three-dimensional modeling processing executed in this embodiment. In this embodiment, the computer 200 first acquires polygon data indicating the shape of a three-dimensional object from an application program or the like being executed on a recording medium, a network or the computer 200 (step S10). When the polygon data is acquired, the computer 200 separates the images on the surfaces of polygons that are represented by the polygon data into the colors C, M, Y and BK (step S20).

Subsequently after performing color separation on the images on the surfaces of the polygons, the computer 200 slices the polygon data in accordance with the modeling resolution in the Z direction, and generates bitmap data for each cross section (step S40). At this time, in each piece of the cross-sectional data, the computer 200 stores values indicating the gradation values of chromatic colors (C, M, and Y) at coordinates corresponding to the outermost periphery of the cross-sectional body (outermost periphery coordinates), based on the surface images of the polygons. In addition, in each piece of the cross-sectional data, the computer 200 stores a value indicating the gradation value of BK at the above-described outermost periphery coordinates or coordinates corresponding to positions adjacent to the outermost periphery in the depth direction of the cross-sectional body, based on the surface images of the polygons. For example, values indicating the gradation values of C, M, and Y may be stored at the outermost periphery coordinates, and a value indicating the gradation value of BK may be stored at the adjacent coordinates. In addition, values indicating the gradation values of one or two colors out of C, M, and Y, and a value indicating the gradation value of BK may be stored at the outermost periphery coordinates, and a value for discharging clear ink (at least one of CL1 and CL2) may be stored at the adjacent coordinates. The value for discharging clear ink is stored at coordinates inward of the outermost periphery coordinates and adjacent coordinates.

When the bitmap data has been generated for each cross section, the control unit 70 of the three-dimensional modeling apparatus 100 receives the bitmap data from the computer 200, controls the units such as the head unit 50 in accordance with the received bitmap data, and models the three-dimensional object (step S50). As described above, the gradation values of chromatic colors (C, M, and Y) are recorded at the outermost periphery coordinates of each piece of the cross-sectional data, the gradation value of BK is recorded at the outermost periphery coordinates or adjacent coordinates, and the value for discharging clear ink is stored at coordinates inward of the outermost periphery coordinates and adjacent coordinates. Therefore, in step S50, an object that is transparent inside and is colored near the surface is modeled. In step S50, the control unit 70 models the three-dimensional object in accordance with the following method.

FIGS. 4A and 4B are diagrams for explaining a method for modeling a three-dimensional object. The control unit 70 that received the bitmap data controls the head unit 50 to cause a curable liquid of a designated amount and a designated type (at least one of colored ink and colorless ink) to be discharged at coordinates designated in the bitmap data. In other words, the control unit 70 controls the head unit 50 so as to causes the curable liquid to be discharged into each of the unit grilles UG constituting virtual three-dimensional grilles DL shown in FIG. 4A, thereby modeling the object. The unit grille UG herein refers to a virtual three dimensional region that has a minimum spatial volume that is in accordance with modeling resolutions of a cross section body in the X direction and the Y direction, and the lamination interval of the cross section body in the Z direction, and one unit grille UG corresponds to one coordinate in the bitmap data. The control unit 70 completes a cross section body for a first layer by causing the curable liquid to be discharged into the unit grilles UG constituting the first layer of the three-dimensional grilles DL based on cross section data (bitmap data) of the first layer, and after that, completes a cross section body for a second layer by causing the curable liquid to be discharged into the unit grilles UG constituting the second layer based on cross section data of the second layer. By repeating this processing up to an Nth layer, the three-dimensional object as a laminated body is formed. The unit grille UG is also referred to as a voxel.

In the case where the gradation values of chromatic colors (C, M, and Y) are recorded at the outermost periphery coordinates of each piece of the cross-sectional data, and the gradation value of BK is recorded at the adjacent coordinates, the head unit 50 discharges, into two unit grilles (UG1a and UG2b, or UG1c and UG2d) continuously aligned in a direction from the surface side to the interior side of the object (the depth direction), colored ink that has been designated for each of the two unit grilles, as shown in FIG. 4B. However, in the case where the gradation values of C, M, Y and BK are recorded at the outermost periphery coordinates, and a value for discharging CL is recorded at the adjacent coordinates, the head unit 50 discharges designated colored ink into a unit grille (UG1a or UG1c) corresponding to the surface of the object, and discharges clear ink into a unit grille (UG2b or UG2d) adjacent to this unit grille in the depth direction. Here, the unit grille UG1a is a unit grille corresponding to the bottom surface of the object, and the bottom surface of the unit grille UG1a constitutes the bottom surface of the object. The unit grille UG2b is a unit grille positioned above the unit grille UG1a and aligned with the unit grille UG1a in the Z direction. The unit grille UG1c is a unit grille corresponding to a side surface of the object, and a hatched portion in FIG. 4B indicates an outer surface of the object. A unit grille UG2d is a unit grille that is positioned on the side opposite to the unit grille UG1c side constituting the outer surface of the object (hatched portion side), and that is aligned with the unit grille UG1c in the X direction or Y direction. The unit grille UG1a and the unit grille UG1c correspond to the outermost periphery coordinates of the bitmap data. In addition, the unit grille UG2b and the unit grille UG2d correspond to the adjacent coordinates of the bitmap data. The unit grille UG1a and the unit grille UG1c of this embodiment correspond to “first unit grilles” in the claims, and the unit grille UG2b and the unit grille UG2d correspond to “second unit grilles” in the claims.

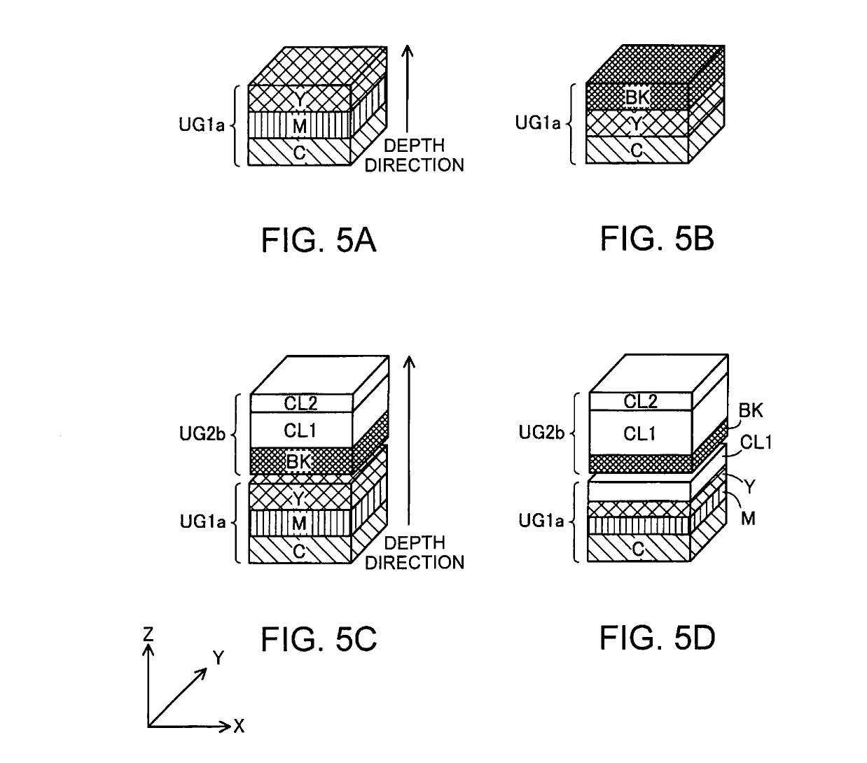

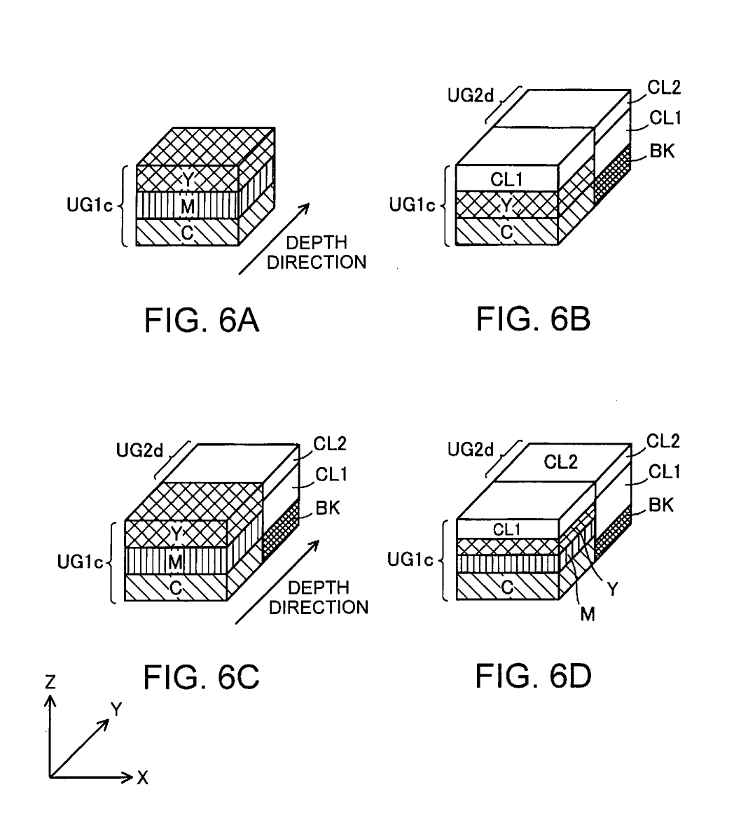

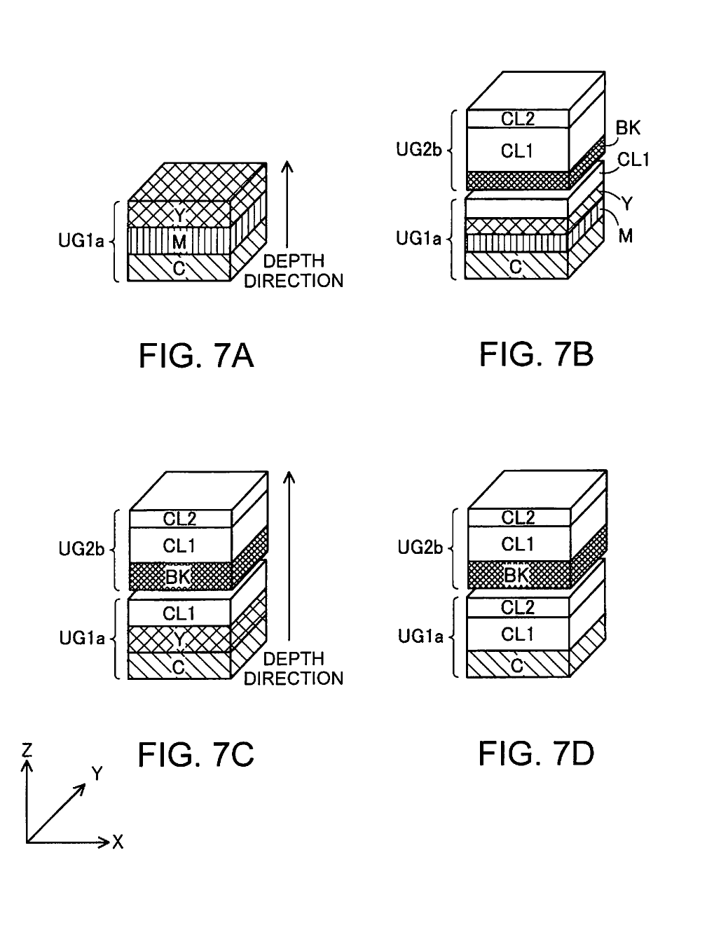

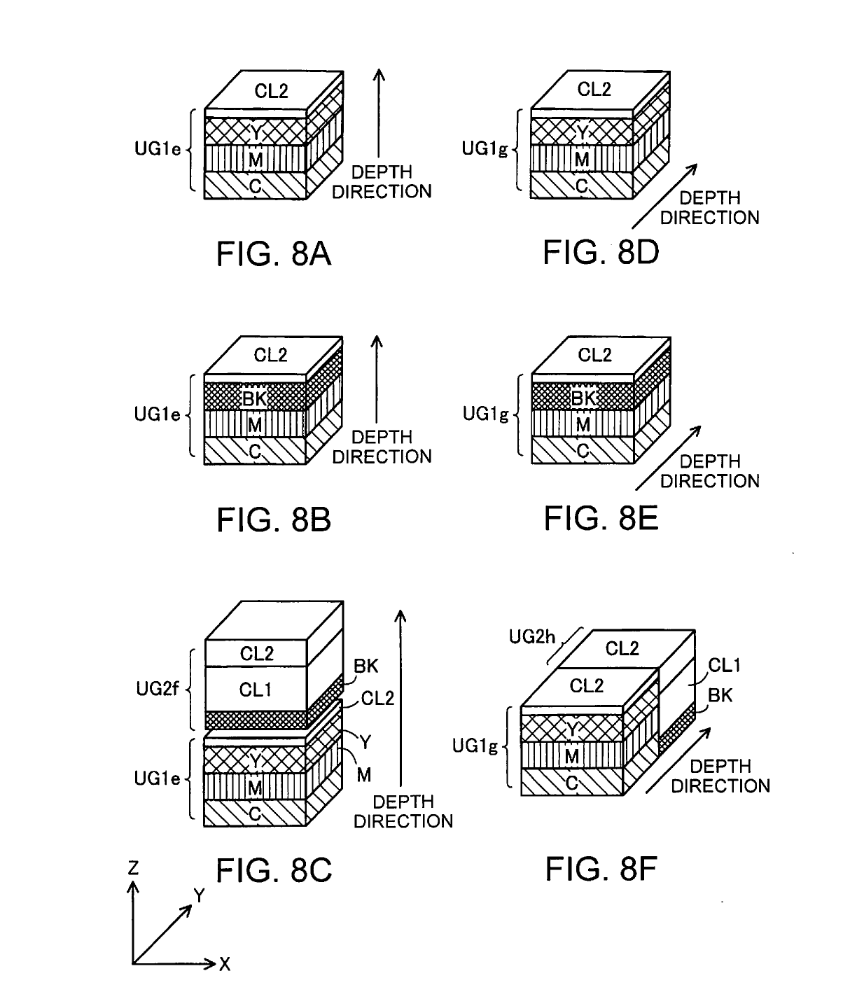

As described above, chromatic ink is discharged into the first unit grilles UG1a and UG1c, BK ink is discharged into the first unit grilles UG1a and UG1c or the second unit grilles UG2b and UG2d, and only colorless ink is discharged into unit grilles UG that are inward of the first and second unit grilles UG1a, UG2b, UG1c, and UG2d. Therefore, an object is modeled in which an inner portion surrounded by the first and second unit grilles UG1a to UG2d is transparent, and a surface portion corresponding to the first and second unit grilles UG1a to UG2d is colored. The control unit 70 discharges colored ink and colorless ink into the unit grilles UG1a and the unit grilles UG2b in accordance with a method shown in FIGS. 5A to 5D and FIGS. 6A to 6D, which will be described later. The control unit 70 also discharges colored ink and colorless ink into the unit grilles UG1c and the unit grilles UG2d in accordance with a method shown in FIGS. 7A to 7D and FIGS. 8A to 8F, which will be described later.

FIGS. 5A to 5D are diagrams for explaining a method for expressing a color of the bottom surface of an object. In FIGS. 5A to 5D, a unit grille column UC that includes the unit grille UG1a and the unit grille UG2b after colored ink and colorless ink were discharged is illustrated. The color of the bottom surface of the object observed from the bottom surface side (Z direction side) of the unit grille UG1a is expressed by the combination of colored ink discharged into the unit grille UG1a in FIG. 5A and FIG. 5B, and is expressed by the combination of colored ink discharged into the two unit grilles UG1a and UG2b in FIGS. 5C and 5D. The control unit 70 causes colored ink (C, M, Y, and BK) to be discharged into the unit grille UG1a, and in the case where the spatial volume of the unit grille UG1a is not filled with the colored ink, causes the clear ink CL to be discharged into the unit grille UG1a in addition to the colored ink, whereby the spatial volume of the unit grille UG1a is filled with both the colored ink and colorless ink. Therefore, regardless of the type and amount of the colored ink discharged into the unit grilles UG1a, all of the total volumes of ink discharged into the unit grilles UG1a are the same. In addition, in the case where BK ink has not been discharged into the unit grille UG2b, and in the case where the spatial volume of the unit grille UG2b is not filled with BK ink as in FIGS. 5C and 5D, the control unit 70 causes the clear ink CL to be discharged into the unit grille UG2b, and thereby the spatial volume of the unit grille UG2b is filled with colorless ink, or both the colorless ink and the BK ink. Therefore, regardless of the amount of BK ink discharged into the unit grilles UG, all the total volumes of ink discharged into the unit grilles UG2b are the same. Note that in the case of this embodiment for modeling an object using powder, the spatial volume of the unit grille UG is a volume obtained by subtracting the volume of the powder included in the unit grille UG from the volume of the unit grille UG, and colored ink and colorless ink are discharged such that the spatial volume is substantially filled.

In the case of discharging one to three types of colored ink out of four types of colored ink (C, M, Y, and BK) into the unit grille UG1a and the unit grille UG2b that make up a pair, the control unit 70 causes all of these types of ink to be discharged into the unit grille UG1a, as shown in FIGS. 5A and 5B. At this time, in the case where colored ink to be discharged includes BK ink, the ink is discharged such that the BK ink is positioned on the interior side of the object relative to chromatic ink (C, M, and Y) as shown in FIG. 5B. Here, the control unit 70 causes the BK ink to be discharged above the chromatic ink, thereby arranging the BK ink on the interior side of the object relative to the chromatic ink (C, M, and Y). In the case of discharging all of the four types of colored ink (C, M, Y, and BK) into the unit grille UG1 a and the unit grille UG2b that make up the pair, the control unit 70 causes chromatic ink (C, M, and Y) to be discharged into the unit grille UG1a, and causes BK ink to be discharged into the unit grille UG2b as shown in FIGS. 5C and 5D. In this case as well, the BK ink is positioned on the interior side of the object relative to the chromatic ink.

The head unit 50 of this embodiment selects a discharge amount of colored ink per droplet from among four types, that is, “none (no discharge)”, “small”, “intermediate”, and “large” in accordance with the magnitude of the gradation value in the bitmap data. Specifically, the control unit 70 controls the head unit 50 so as to discharge an ink amount determined using a lookup table in which the gradation values in the bitmap data obtained from the computer 200 are associated with the discharge rates of discharge amounts “small”, “intermediate” and “large” of these ink colors, and a dither matrix of each of the ink colors. The discharge rate indicates a probability of ink droplets being to be discharged into the unit grille of the relevant portion. In this embodiment, the head unit 50 discharges 2 pl of colored ink in the case where the discharge amount is “small”, 4 pl of colored ink in the case of “intermediate”, and 6 pl of colored ink in the case of “large”. In this embodiment, the discharge amount of ink of each color has four levels, but may have more detailed levels or broader levels in accordance with the ability of the head unit 50 to adjust the discharge amount.

When a discharge amount of colored ink is selected based on the bitmap data as described above, the control unit 70 determines an amount of clear ink to be discharged into the unit grille UG into which the colored ink is to be discharged, in accordance with the selected discharge amount of the colored ink. Specifically, the control unit 70 determines the discharge amount of clear ink such that the total of the discharge amount of the colored ink and the discharge amount of the clear ink equals the spatial volume of the unit grille UG. Here, description will be given assuming that the volume of each of the unit grilles UG is filled with 18 pl. The head unit 50 selects a discharge amount of colorless ink per droplet from among four types, that is, “none (no discharge)”, “small”, “intermediate”, and “large”. The head unit 50 discharges 4 pl of the first clear ink CL1 in the case where the discharge amount of the first clear ink CL1 is “small”, 8 pl in the case of “intermediate”, and 10 pl in the case of “large”. The head unit 50 discharges 2 pl of the second clear ink CL2 in the case where the discharge amount of the second clear ink CL2 is “small”, 4 pl in the case of “intermediate”, and 8 pl in the case of “large”. Note that the configurations (type and amount) of the ink in the unit grilles UG shown in FIGS. 5A to 5D are as follows.

Configuration in FIG. 5A
Unit grille UG1a: C “large”+M “large”+Y “large”

Configuration in FIG. 5B
Unit grille UG1a: C “large”+Y “large”+BK “large”

Configurations in FIG. 5C
Unit grille UG1a: C “large”+M “large”+Y “large”
Unit grille UG2b: BK “large”+CL1 “intermediate”+CL2 “intermediate”

Configurations in FIG. 5D
Unit grille UG1a: C “large”+M “intermediate”+Y “intermediate”+CL1 “small”
Unit grille UG2b: BK “intermediate”+CL1 “large”+CL2 “intermediate”

FIGS. 6A to 6D are diagrams for explaining a method for expressing a color of a side surface of an object. In FIGS. 6A to 6D, the unit grille UG1c and the unit grille UG2d after colored ink and colorless ink were discharged are illustrated. The configurations of ink in the unit grilles UG shown in FIGS. 6A, 6C and 6D respectively correspond to the configurations of ink shown in FIGS. 5A, 5C and 5D. In FIG. 6A, the color of a side surface of the object observed from a side surface side (Y direction side) of the unit grille UG1c is expressed by the combination of colored ink discharged into the unit grille UG1c, and in FIGS. 6B to 6D, it is expressed by the combination of colored ink discharged into two unit grilles UG1c and UG2d. As shown in FIGS. 6A to 6D, the control unit 70 causes chromatic ink (C, M, and Y) to be discharged into the unit grille UG1c, and in the case of discharging BK ink, causes the BK ink to be discharged into the unit grille UG2d. Accordingly, the BK ink is positioned on the interior side of the object relative to the chromatic ink. In the case where the spatial volumes of the unit grilles UG1c and UG2b are not filled with the colored ink, the control unit 70 causes the clear ink CL to be discharged into these unit grilles UG1c and UG2b in addition to the colored ink. Therefore, regardless of the amounts of colored ink discharged into the unit grilles UG1c and UG2b, all of the total volumes of ink discharged into the unit grilles UG1c and UG2b are the same.

According to the three-dimensional modeling apparatus 100 of this embodiment described above, as shown in FIGS. 5A to 6D, it is possible to adjust the amount of chromatic liquid to be discharged into the unit grille UG in a unit finer than the unit grille UG that is in accordance with the modeling resolution, and therefore, when modeling a colored three-dimensional object, it is possible to suppress deterioration of the apparent resolution of the three-dimensional object compared with a case in which the coloring is performed using only one color for one unit grille UG. In addition, these liquids are discharged such that the black liquid is positioned on the interior side of the object relative to the chromatic liquid, and therefore it is possible to suppress the deterioration of chromatic color reproducibility due to the black liquid, when observed from the surface of the object. In addition, in this embodiment, in the case where the spatial volume of a unit grille UG is not filled with the amount of colored liquid discharged into the unit grille UG, the remaining spatial volume of the unit grille UG is filled with colorless liquid. Therefore, the volumes of the unit grilles are uniformized, and the three-dimensional object can be accurately modeled.

With the three-dimensional modeling apparatus 100 of this embodiment, as shown in FIG. 2, in the main scanning direction, the second nozzle group 54 for discharging a black liquid into the unit grille UG is arranged rearward of the first nozzle group GN1 for discharging a chromatic liquid into the unit grille UG, the third nozzle group 55 for discharging a colorless liquid into the unit grille UG is arranged rearward of the second nozzle group 54, and the fourth nozzle group 56 for discharging a colorless liquid into the unit grille UG is arranged rearward of the third nozzle group 55. Therefore, the black liquid can be discharged from the second nozzle group 54 after the chromatic liquid is discharged from the first nozzle group GN1, and thus the black liquid can be more easily arranged on the interior side of the object relative to the chromatic liquid. In addition, for example, even in the case where the total amount of the liquids discharged from the first nozzle group GN1 and the second nozzle group 54 is small, and the amount of colorless liquid necessary to fill the unit grille UG with a liquid is larger than the amount that can be discharged from either the third nozzle group 55 or the fourth nozzle group 56, the unit grille UG can be filled with a liquid by sequentially discharging the colorless liquid from two nozzle groups, namely, the third nozzle group 55 and the fourth nozzle group 56. Therefore, it is possible to more easily uniformize the volumes of the unit grilles.

### A2. Modification of First Embodiment

FIGS. 7A to 7D are diagrams showing examples of the unit grille UG1a and the unit grille UG2b in a modification of the first embodiment. In the first embodiment, description was given assuming that in the case where one to three types of colored ink including BK ink is discharged into the unit grille UG1a and the unit grille UG2b that make up a pair, all of these types of ink are discharged into the unit grille UG1a. However, a configuration may be adopted in which the BK ink is always discharged into the unit grille UG2b regardless of the number of types of colored ink discharged into the unit grille UG1a. If this configuration is adopted, the control unit 70 causes chromatic ink (C, M, and Y) to be always discharged into the unit grille UG1a as shown in FIGS. 7A to 7D, and in the case of discharging BK ink, causes the BK ink to be always discharged into the unit grille UG2d, as shown in FIGS. 7B to 7D. For example, as shown in FIG. 7C, in the case of discharging three types of colored ink including the BK ink into the unit grille UG1a and the unit grille UG2b that make up a pair, chromatic ink of two colors is discharged into the unit grille UG1a, and the BK ink is discharged into the unit grille UG2b instead of the unit grille UG1a. In this case as well, the BK ink is positioned on the interior side of the object relative to the chromatic ink, and therefore it is possible to suppress the deterioration of chromatic color reproducibility due to the BK ink, when observed from the surface of the object.

### B. Second Embodiment

FIGS. 8A to 8F are diagrams showing examples of unit grilles in a second embodiment. In FIGS. 8A to 8C, a unit grille UG1e and a unit grille UG2f after colored ink and colorless ink were discharged are illustrated, and in FIGS. 8D to 8F, a unit grille UG1g and a unit grille UG2h are illustrated. The unit grilles UG1e to UG2h of the second embodiment are configured such that clear ink is necessarily discharged into the top portion.

The head unit of the second embodiment has the same configuration as that of the head unit 50 of the first embodiment (FIG. 2), except that the amounts of the second clear ink CL2 to be discharged are different. The discharge amounts of colored ink and the first clear ink CL1 are the same as in the first embodiment. That is, the head unit of the second embodiment discharges 2 pl of colored ink in the case where the discharge amount of the colored ink is “small”, 4 pl of colored ink in the case of “intermediate”, and 6 pl of colored ink in the case of “large”. This head unit discharges 4 pl of the first clear ink CL1 in the case where the discharge amount of the first clear ink CL1 is “small”, 8 pl of the first clear ink CL1 in the case of “intermediate”, and 10 pl of the first clear ink CL1 in the case of “large”. The head unit discharges 2 pl of the second clear ink CL2 in the case where the discharge amount of the second clear ink CL2 is “small”, 6 pl of the second clear ink CL2 in the case of “intermediate”, and 10 pl of the second clear ink CL2 in the case of “large”. The control unit of the second embodiment determines the discharge amount of clear ink such that the total of the discharge amount of colored ink and the discharge amount of the clear ink equals the spatial volume of the unit grille UG. Here, description will be given assuming that the spatial volume of each of the unit grilles UG is filled with 20 pl. The configurations of ink in the unit grilles UG shown in FIG. 8A to 8C are as follows. The configurations of ink in the unit grilles UG shown in FIG. 8D to 8F are the same as the configurations of ink in FIG. 8A to 8C.

Configuration in FIG. 8A
Unit grille UG1e: C “large”+M “large”+Y “large”+CL2 “small”

Configuration in FIG. 8B
Unit grille UG1e: C “large”+M “large”+BK “large”+CL2 “small”

Configurations in FIG. 8C
Unit grille UG1e: C “large”+M “large”+Y “large”+CL2 “small”
Unit grille UG2f: BK “intermediate”+CL1 “large”+CL2 “intermediate”

According to the second embodiment described above, a layer made of colorless liquid is necessarily formed at the top portion of a unit grille UG, and therefore it is possible to uniformize the way that colored liquid (C, M, Y, and BK) discharged into the unit grille UG spreads in the unit grille UG. In other words, the colored liquid discharged into the unit grille UG spreads differently after landing in the case of landing on colored liquid and in the case of landing on colorless liquid. Therefore, if the top portion of the unit grille UG is always constituted by colorless liquid, it is possible to cause the colored liquid that is discharged into another unit grille UG above this unit grille UG to always land on the colorless liquid. For example, as shown in FIG. 8C, it is possible to cause the black liquid discharged into the unit grille UG2f to land on the second clear ink CL2 formed at the top portion of the unit grille UG1e. Thereby, it is possible to uniformize the way that the colored liquid spreads after landing.

### C. Third Embodiment

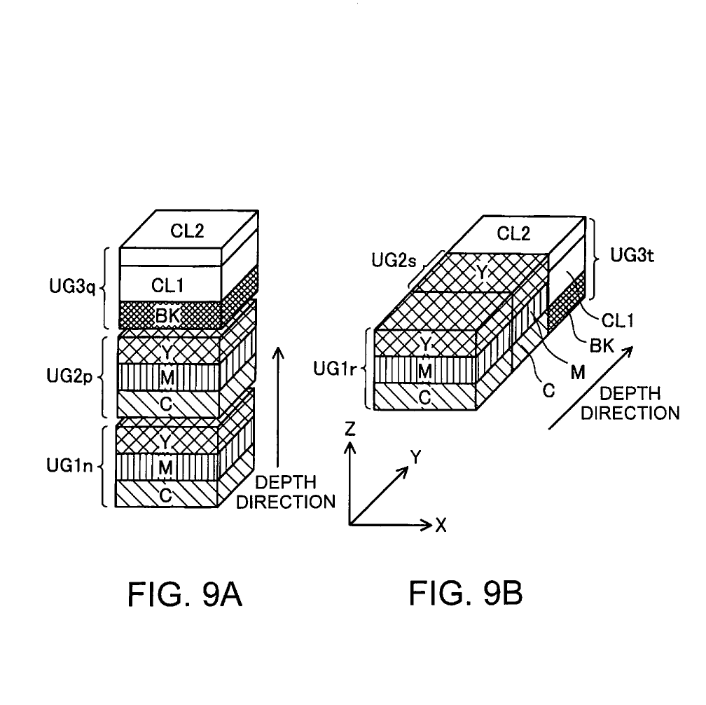

FIGS. 9A and 9B are diagrams showing examples of unit grilles UG in a third embodiment. In FIG. 9A, a unit grille UG1n, a unit grille UG2p and a unit grille UG3q after colored ink and colorless ink were discharged are illustrated, and in FIG. 9B, a unit grille UG1r, a unit grille UG2s and a unit grille UG3t are illustrated. The number of unit grilles UG used for expressing one color of the surface of an object is not limited to two. In the third embodiment, one color of the outer face of an object is expressed using colored ink discharged into three unit grilles UG. In other words, in FIG. 9A, the color of the bottom surface of the object observed from the bottom surface side (Y direction side) of the unit grille UG1n is expressed by the combination of colored ink discharged into the unit grilles UG1n to UG3q, and in FIG. 9B, the color of a side surface of the object observed from the side surface side (Y direction side) of the unit grille UG1r is expressed by the combination of colored ink discharged into the unit grilles UG1r to UG3t. The control unit of the third embodiment determines a discharge amount of clear ink such that the total of the discharge amount of colored ink and the discharge amount of the clear ink equals the spatial volume of each of the unit grilles UG, similarly to the first embodiment. In addition, the control unit causes the ink to be discharged such that BK ink is positioned on the interior side of the object relative to chromatic ink. Here, the spatial volume of each of the unit grilles UG is illustrated assuming that it is filled with 18 pl. The configurations of ink in the unit grilles UG shown in FIG. 9A are as follows. The configurations of ink in the unit grilles UG shown in FIG. 9B are similar to the configurations of ink in FIG. 9A. With these configurations as well, BK ink is positioned on the interior side of the object relative to chromatic ink, and therefore, it is possible to suppress the deterioration of chromatic color reproducibility due to the BK ink, when observed from the surface of the object.

Configurations in FIG. 9A
Unit grille UG1n: C “large”+M “large”+Y “large”
Unit grille UG2p: C “large”+M “large”+Y “large”
Unit grille UG3q: BK “large”+CL1 “intermediate”+CL2 “intermediate”

### D. Fourth Embodiment

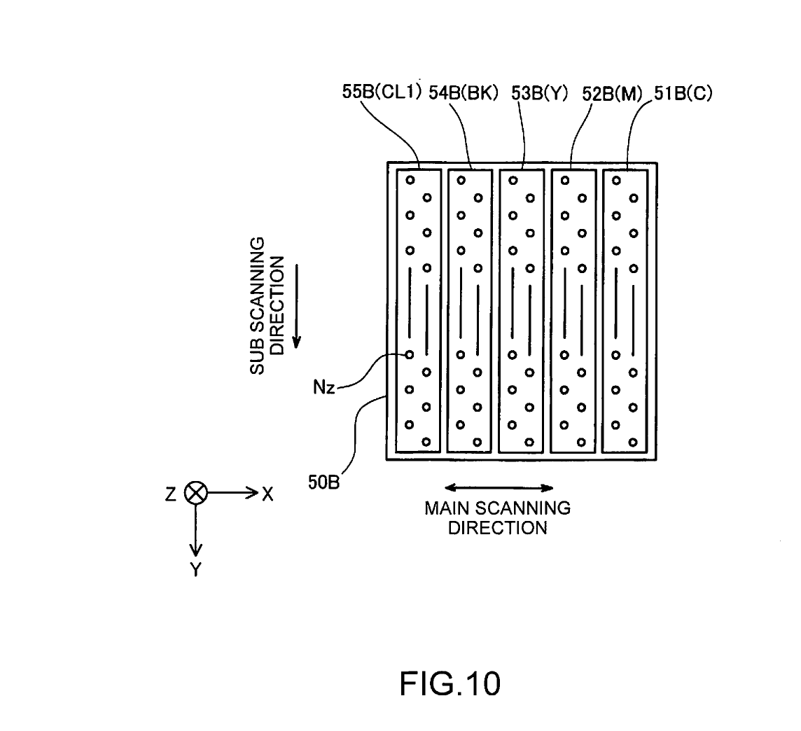

FIG. 10 is an explanatory diagram showing the schematic configuration of a head unit 50B of a fourth embodiment. The head unit 50B of the fourth embodiment is different from the head unit 50 of the first embodiment in that the number of nozzle groups for discharging clear ink is one. With this configuration as well, in the case where the spatial volume of each of the unit grilles UG is not filled with the amount of colored ink discharged into the unit grille UG, the remaining spatial volume of the unit grille UG is filled with clear ink. Therefore, the volumes of the unit grilles UG are uniformized. Therefore, the three-dimensional object can be accurately modeled.

### E. Fifth Embodiment

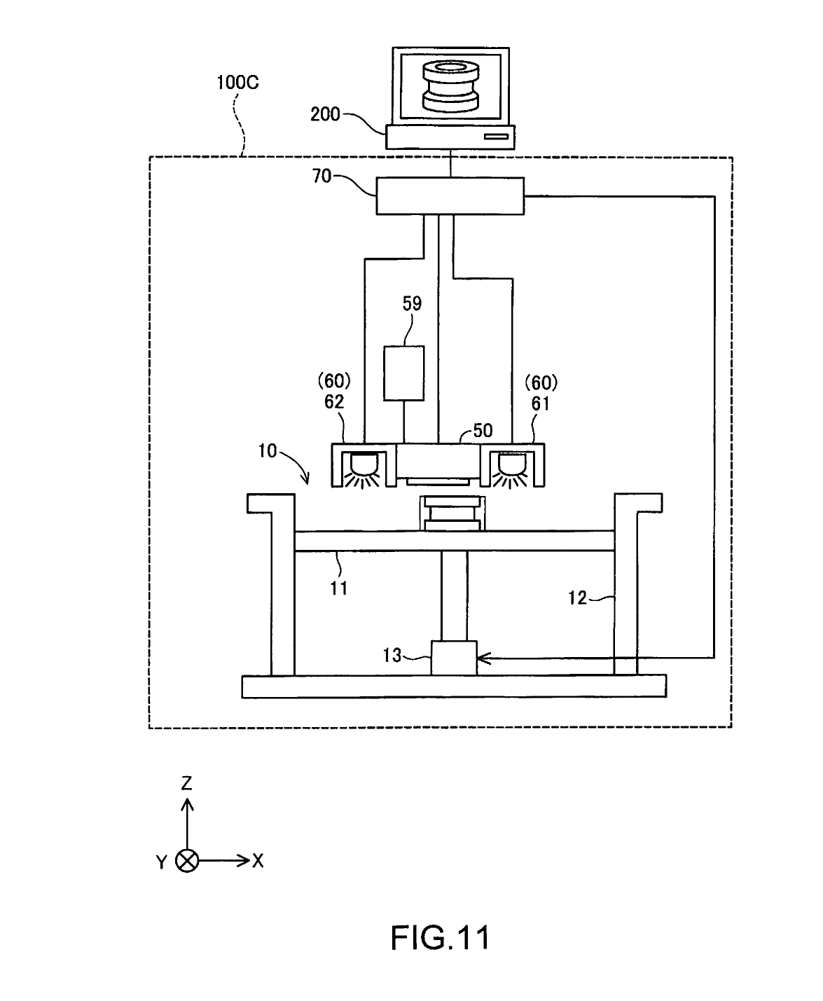

FIG. 11 is an explanatory diagram showing the schematic configuration of a three-dimensional modeling apparatus in a fifth embodiment. The three-dimensional modeling apparatus 100 of the first embodiment models a three-dimensional object by discharging a curable liquid onto powder supplied into the modeling unit 10. On the other hand, a three-dimensional modeling apparatus 100C of the fifth embodiment models a three-dimensional object using only a curable liquid containing resin, without using powder.

The three-dimensional modeling apparatus 100C is provided with the modeling unit 10, the head unit 50, the curing energy applying unit 60 and the control unit 70. The modeling unit 10 is provided with the modeling stage 11, the frame body 12 and the actuator 13 similarly to the first embodiment. However, the frame body 12 may be omitted. The tank 59 is connected to the head unit 50. The curing energy applying unit 60 is provided with the main curing light emitting apparatus 61 and the provisional curing light emitting apparatus 62. That is, the three-dimensional modeling apparatus 100C has many portions in common with the configuration of the three-dimensional modeling apparatus 100 of the first embodiment, and has a configuration in which the powder supply unit 20, the flattening mechanism 30 and the powder collecting unit 40 are omitted from the three-dimensional modeling apparatus 100 of the first embodiment. Such a three-dimensional modeling apparatus 100C can also model a three-dimensional object by the same processing as that of the three-dimensional modeling apparatus 100 of the first embodiment, except for the processing for forming a powder layer. Note that in the case of this embodiment, colored ink and colorless ink are discharged into the spatial volume of the unit grille UG such that the volume of the discharged ink is substantially the same as the volume of the unit grille UG.

### F. Modifications

Modification 1

In the above embodiments, the three-dimensional modeling apparatus 100 colors the outermost periphery of a three-dimensional object, but clear ink for protecting a colored portion may be discharged onto the outer periphery side of the colored portion.

Modification 2

A value for discharging white ink may be stored at inner coordinates that are adjacent to the adjacent coordinates in the bitmap data. If the white ink is arranged at the coordinates inward of the adjacent coordinates, the ground color becomes white, and thus it is possible to improve the reproducibility of the color that is added. In addition, colorless ink arranged inward of colored ink in the depth direction may be white ink instead of clear ink. If the colorless ink arranged inside is white ink, the ground color can be white, and thus gradation expression using the colored ink can be more accurately performed.

Modification 3

A configuration may be adopted in which the three-dimensional modeling apparatus 100 colors only the bottom surface of an object by causing colored ink to be discharged into the unit grille UG1a and the unit grille UG2b (FIG. 4), and does not color a side surface of the object by not causing colored ink to be discharged into the unit grille UG1c and the unit grille UG2d. Conversely, a configuration may also be adopted in which a side surface of the object is colored and the bottom surface is not colored.

Modification 4

The alignment orders of the nozzle groups for discharging chromatic ink in these embodiments are examples, and are not limited by the above embodiments. In other words, in the above embodiments, the color of arbitrary chromatic ink can be replaced by the color of other arbitrary chromatic ink.

Modification 5

In the above embodiments, the head unit 50 relatively moves in the Z direction by the modeling stage 11 moving in the Z direction. However, the position of the modeling stage 11 may be fixed and the head unit 50 may be moved directly in the Z direction. In addition, the head unit 50 moves in the X direction and the Y direction in the above embodiments, but the position of the head unit 50 may be fixed in the X direction and the Y direction, and the modeling stage 11 may be moved in the X direction and the Y direction.

Modification 6

In the above embodiments, out of three-dimensional modeling processes shown in FIG. 3, the processes of steps S10 to S40 are executed by the computer 200. However, those processes may be executed by the three-dimensional modeling apparatus 100. That is, the three-dimensional modeling apparatus 100 may execute all the processes from the acquisition of polygon data to the modeling of a three-dimensional object by itself. In addition, in the above embodiments, the process of step S50 shown in FIG. 3 is executed by the control unit 70 of the three-dimensional modeling apparatus 100. However, the process of step S50 may be executed by the computer 200 controlling the units of the three-dimensional modeling apparatus 100. That is, the computer 200 may perform the functions of the control unit 70 of the three-dimensional modeling apparatus 100.

The invention is not limited to the above embodiments, examples, and modifications, and can be achieved in various configurations without departing from the gist of the invention. For example, the technical features in the embodiments, examples, and modifications corresponding to the technical features in the modes can be replaced or combined as appropriate in order to solve some or all of the problems described above, or in order to achieve some or all of the aforementioned effects. Technical features that are not described as essential in the specification can be deleted as appropriate.

The entire disclosure of Japanese patent No. 2015-050169, filed Mar. 13, 2015 is expressly incorporated by reference herein.

What is claimed is:

1. A three-dimensional modeling apparatus for modeling a three-dimensional object by laminating a plurality of cross section bodies in a Z direction, the three-dimensional modeling apparatus comprising:
a head unit for modeling the object by discharging a liquid that is to be a material of the object into each unit grille that is defined in accordance with a modeling resolution of the cross section body in an X direction, a modeling resolution of the cross section body in a Y direction, and a lamination interval of the cross section body in the Z direction; and
a control unit for controlling the head unit,
wherein the head unit is capable of individually discharging, into the unit grille, designated amounts of a plurality of types of chromatic liquids for expressing a designated color, and a low-lightness liquid that is an achromatic liquid having a lower lightness than the chromatic liquid, and
in a case of discharging the low-lightness liquid and the chromatic liquid into one unit grille, the control unit controls the head unit so as to discharge the liquids such that the low-lightness liquid is positioned on an interior side of the object relative to the chromatic liquid.

2. The three-dimensional modeling apparatus according to claim 1,
wherein in a case of discharging the low-lightness liquid and the chromatic liquid into two unit grilles that are adjacent to each other in a direction from a surface to an interior of the object, the control unit controls the head unit so as to discharge the chromatic liquid into a first unit grille positioned on the surface side of the object, and discharge the low-lightness liquid into a second unit grille positioned on the interior side of the object.

3. The three-dimensional modeling apparatus according to claim 1,
wherein the head unit is further capable of discharging a colorless liquid into the unit grille, and
the control unit controls the head unit so as to discharge at least one colored liquid out of the chromatic liquid and the low-lightness liquid into the unit grille and, in a case where the spatial volume of the unit grille is not filled with the colored liquid, discharge the colorless liquid into the unit grille in addition to the colored liquid, such that the spatial volume of the unit grille is filled.

4. The three-dimensional modeling apparatus according to claim 3,
wherein the head unit discharges the liquids into the unit grilles while scanning in a predetermined direction, and is provided with a plurality of nozzle groups for discharging the liquids, and
in a main scanning direction of the head unit, a second nozzle group for discharging the low-lightness liquid into the unit grilles is arranged rearward of a first nozzle group for discharging the chromatic liquid into the unit grilles, a third nozzle group for discharging the colorless liquid into the unit grilles is arranged rearward of the second nozzle group, and a fourth nozzle group for discharging the colorless liquid into the unit grilles is arranged rearward of the third nozzle group.

5. The three-dimensional modeling apparatus according to claim 1,
wherein the head unit is further capable of discharging a colorless liquid into the unit grille, and
the control unit controls the head unit so as to discharge the colorless liquid onto a top portion of the unit grille into which at least one of the chromatic liquid and the low-lightness liquid was discharged.

6. A method for manufacturing a three-dimensional object using a three-dimensional modeling apparatus for modeling a three-dimensional object by laminating a plurality of cross section bodies in a Z direction,
the three-dimensional modeling apparatus including a head unit for modeling the object by discharging a liquid that is to be a material of the object into each unit grille that is defined in accordance with a modeling resolution of the cross section body in an X direction, a modeling resolution of the cross section body in a Y direction, and a lamination interval of the cross section body in the Z direction, and
the head unit being capable of individually discharging, into the unit grille, designated amounts of a plurality of types of chromatic liquids for expressing a designated color, and a low-lightness liquid that is an achromatic liquid having a lower lightness than the chromatic liquid,
the method comprising controlling, in a case of discharging the low-lightness liquid and the chromatic liquid into one unit grille, the head unit so as to discharge the liquids such that the low-lightness liquid is positioned on an interior side of the object relative to the chromatic liquid.
